(19) United States
(12) Patent Application Publication
(10) Pub. No.: US 2010/0262418 A1
(43) Pub. Date: Oct. 14, 2010

(54) METHOD AND APPARATUS OF COMPUTER PROCESSING OF A BRAHMIC SCRIPT

(76) Inventor: SHAH MUSA, San Jose, CA (US)

Correspondence Address: Raj Abhyanker, P.C., 1580 West, El Camino Real, Suite 8, Mountain View, CA, 94040, US

(21) Appl. No.: 12/420,823

(22) Filed: Apr. 9, 2009

(51) Int. Cl. G06F 17/28

(52) U.S. Cl. 704/2; 704/260; 704/235

(57) ABSTRACT

Several methods and an apparatus of computer processing of a simplified Brahmic script are disclosed. An exemplary embodiment provides a computer implemented method. An encoded alphanumeric character of a computer input device is defined as a encoded phonemic character of a simplified Brahmic alphabet. The encoded phonemic character of a simplified Brahmic alphabet includes a conjunct-free writing system derived from a specified Brahmic script. The encoded alphanumeric character and the encoded phonemic character have a one-to-one relationship. The encoded phonemic character is associated with a specified glyph encoding of the specified Brahmic script. In a computing device the encoded phonemic character is converted to the specified glyph encoding and vice versa.

### FIELD OF TECHNOLOGY

This disclosure relates generally to a processing text with a computer and more particularly to processing Brahmic scripts with a computer.

### BACKGROUND

A Brahmic script may use an abugidic writing system. An abugida may include a conjunct. A possible number of forms of the conjuncts may be exponentially larger than the characters of a conjunct-free writing system (e.g. Latin alphabet). The possible number of conjuncts may render the Brahmic script complex and difficult to learn and use. Additionally, the possible number of forms of combined conjuncts may render the Brahmic script difficult to utilize with a computer.

### SUMMARY

This Summary is provided to comply with 37 C.F.R. 1.73, requiring a summary of the invention briefly indicating the nature and substance of the invention. It is submitted with the understanding that it will not be used to interpret or limit the scope or meaning of the claims.

Several methods and a system relating to computer process of a simplified Brahmic script processing are disclosed.

An exemplary embodiment provides a computer implemented method. An encoded alphanumeric character of a computer input device is defined as an encoded phonemic character of a simplified Brahmic alphabet. The encoded phonemic character of a simplified Brahmic alphabet includes a conjunct-free writing system derived from a specified Brahmic script. The encoded alphanumeric character and the encoded phonemic character have a one-to-one relationship. The encoded phonemic character is associated with a specified glyph encoding of the specified Brahmic script. In a computing device the encoded phonemic character is converted to the specified glyph encoding.

The specified glyph encoding of the specified Brahmic script is rendered into a specified conjunct form according to a list of allowed conjuncts of the specified Brahmic script if the encoded phonemic character comprises a consonant. The specified glyph encoding of the specified Brahmic script is algorithmically generated into at least one of an independent form and a diacritic form if the phonemic character includes a vowel. A diphthong is defined as a specified combination of phonemic vowel encodings. A long vowel is defined as another specified combination of phonemic vowel encodings.

An exemplary embodiment provides a system of conjunct-free writing system derived from a Brahmic alphabet. The system includes a computer input device. The system also includes a mapping module of a computer to define an encoded alphanumeric character of the computer input device as an encoded phonemic character of a simplified Brahmic alphabet including a conjunct-free writing system derived from a specified Brahmic script. The encoded alphanumeric character and the encoded phonemic character have a one-to-one relationship. In addition, the system includes a matching module of the computer to associate the encoded phonemic character with a specified glyph encoding of the specified Brahmic script. Further, the system includes an encoder module of the computer to convert the encoded phonemic character to the specified glyph encoding.

An exemplary embodiment provides a method of mapping an encoding of a phonemic character of a simplified script including a conjunct-free writing system of phonemic characters derived from an abugida script with a data associated with a computer input device. The method also includes determining encoded character of the abugida script from which the encoded phonemic character is derived.

The methods and systems disclosed herein may be implemented in any means of achieving various aspects, and may be executed in a form of a machine-readable medium embodying a set of instructions that, when executed by a machine, cause the machine to perform any of the operations disclosed herein. Other features will be apparent from the accompanying Drawings and from the Detailed Description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 illustrates inputting an alphanumeric character through a computer input device to obtain a processed output, according to one embodiment.

FIG. 2 is an exploded view of abugida graphical representation module illustrated in FIG. 1, according to one embodiment.

FIG. 3 is a tabular view illustrating the use of Nayanagari basic vowels and their usage, according to one embodiment.

FIG. 4 is a tabular view illustrating the use of compound vowels in Nayanagari, according to one embodiment.

FIG. 5A and 5B is a tabular view illustrating the categorization of the consonants of the Nayanagari alphabet, according to one embodiment.

FIG. 6 is a systematic view illustrating a word processor application to convert an input alphanumeric character into a specified encoded Brahmic script, according to one embodiment.

FIG. 7 is a diagrammatic system view of a data processing system in which any of the embodiments disclosed herein may be performed, according to one embodiment.

FIG. 8 is a flow chart illustrating conversion of QWERTY ASCII input (typed in as characters of a word of a specific simplified phonemic Brahmic script) to Unicode encoding of a specific Brahmic, according to one embodiment.

FIG. 9 is a process flow illustrating encoding alphanumeric character to a specified Brahmic script, according to one embodiment.

FIG. 10 is a process flow illustrating conversion of an encoded phonemic character to a spoken component of the Brahmic language, according to another embodiment.

FIG. 11 is a process flow illustrating conversion of a spoken component of the Brahmic language to the encoded phonemic character, according to another embodiment.

FIG. 12 is a process flow illustrating mapping a phonemic character with a data associated with a computer input device, according to one embodiment.

FIG. 13 illustrates a QWERTY keyboard with a Nobobangla Keyboard Map, according to an embodiment.

Other features of the present embodiments will be apparent from the accompanying Drawings and from the Detailed Description that follows.

### DETAILED DESCRIPTION

Several methods and a system of a simplified Brahmic script processing are disclosed.

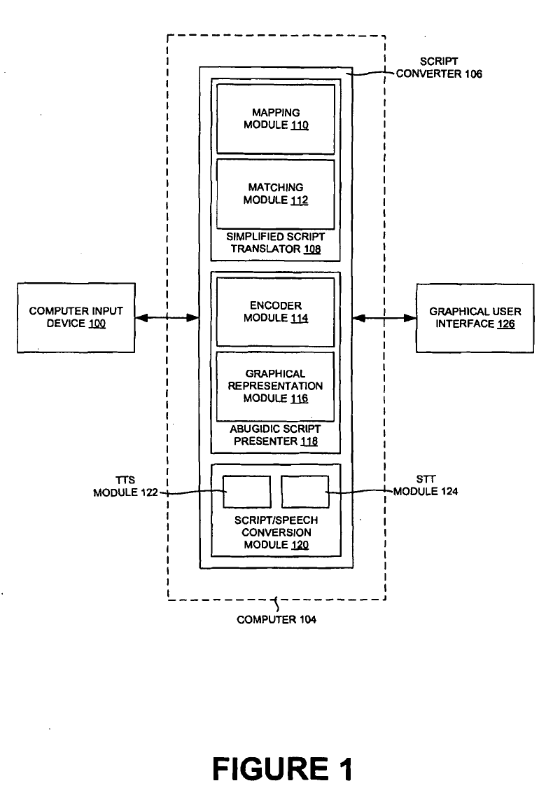

FIG. 1 illustrates inputting an alphanumeric character through a computer input device to obtain a processed output, according to one embodiment. Particularly FIG. 1 illustrates a computer input device 100, a computer 104, a script converter 106, a simplified script translator 108, a mapping module 110, a matching module 112, an encoder module 114, a graphical representation module 116, an abugidic script presenter 118, a script/speech conversion module 120, a text-to-speech (TTS) module 122, a speech-to-text (STT) module 124, and a graphical user interface 126, according to one embodiment.

In an example embodiment, the computer input device may be communicatively coupled with the script converter 106. The script converter 106 may be communicatively coupled with the graphical user interface 126. A user may utilize a word processor application to view an input of the simplified phonetic Brahmic script. The computer 104 may include the script converter 106. The script converter 106 may include the simplified script translator 108, an abugidic script presenter 118, and the script/speech conversion module 120. The simplified script translator 108 may include the mapping module 110 and the matching module 112. The abugidic script presenter 118 may include the encoder module 114. The conjunct script/speech conversion module 120 may include the TTS module 122 and the STT module 124.

The computer input device 100 may be a peripheral (e.g. a piece of computer hardware equipment) used to provide data and control signals to an information processing system. The computer input device may be a QWERTY keyboard. In an example embodiment, the alphanumeric keys of the QWERTY keyboard may have a one-to-one relationship with a simplified Brahmic alphabet. In another embodiment the computer input device 100 may include a touchscreen. In yet another embodiment, the computer input device 100 may include a microphone and a speech-to-text (STT) application.

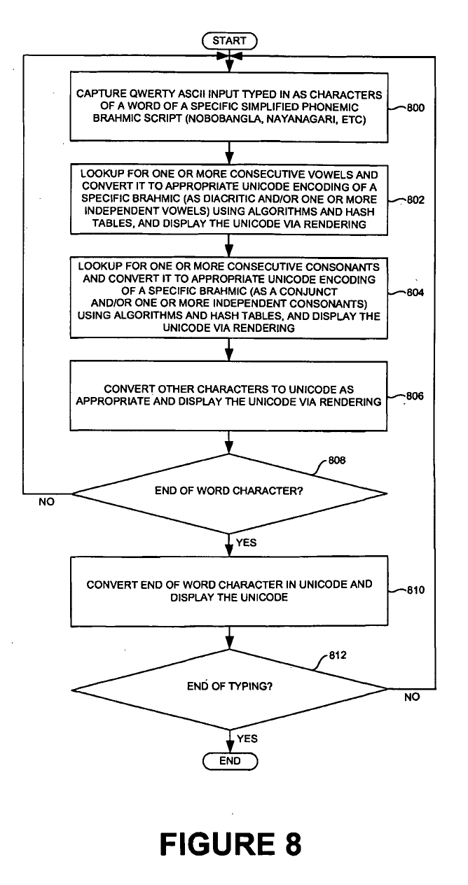

The computer input device 100 may include a script converter 106. The script converter 106 may include a set of hardware circuitry and/or software functionality that may convert a set of data of a computer input device 100 to another set of data capable of being rendered by a computer output device (e.g. the graphical user interface 126) as either the simplified Brahmic script or a Brahmic script. In another example embodiment, the script converter may utilize a set of hardware circuits and software functionality to implement the process represented in FIG. 8 (see below).

A Brahmic script may include the family of alphasyllabaries (writing systems with syllabic alphabets) used in South Asia, Southeast Asia, and parts of Central Asia and East Asia, descended from the Brāhmī script. The Brahmic script may include Indic scripts (e.g. Devanagari script). The Brahmic script may be an abugidic script. The Brahmic script may include consonants with obligatory vowels. Examples of Brahmic scripts may include, inter alia, Devanagari script (used to write Hindi, Marathi, Nepali, Nepal Bhasa, Sanskrit, Pali), Bangla script (used to write Bengali/Bangla, Assamese, Bishnupriya Manipuri), Oriya script, Gujarati script, Ranjana script, Modi script, Gurmukhi script, Telugu script, Tamil script, Kannada script, Malayalam script, Sinhala script, Burmese script, Cambodian script, Lao script, Thai script, Javanese script, Balinese script and Tibetan script.

The mapping module 110 of the computer 104 may include a set of hardware circuitry and/or software functionality to define an encoded alphanumeric character of the computer input device as an encoded phonemic character of the simplified Brahmic alphabet. The mapping module 110 may associate a particular encoded phonemic character with a majuscule encoded alphanumeric character. The mapping module 110 may associate a particular encoded phonemic character with a miniscule encoded alphanumeric character. The phonemic character represented by the encoded phonemic character may be free of an inherent vowel of the specified glyph of the specified Brahmic script from which the phonemic character is derived.

The matching module 112 of the computer 104 may include a set of hardware circuitry and/or software functionality to associate the encoded phonemic character with a specified glyph encoding of the specified Brahmic script.

The encoder module 114 of the computer 104 may include a set of hardware circuitry and/or software functionality to convert the encoded phonemic character to the specified glyph encoding. The encoder module 114 may define a diphthong of the specified Brahmic script as a specified combination of phonemic vowel encodings. The encoder module 114 may define a long vowel of the specified Brahmic script as another specified combination of phonemic vowel encodings.

The graphical representation module 116 to render the specified glyph encoding as a specified glyph of the specified Brahmic script from which the phonemic character is derived according to a rule of the specified Brahmic script. The matching module 112 and/or the graphical representation module 116 may be associated with the abugidic script presenter 118. The abugidic script presenter 118 may include a set of hash tables. The hash tables may include a data structure that associates a particular encoded phonemic character (a key) with a specified glyph encoding (a value). The specified glyph encoding may include a conjunct (e.g. a conjunct consonant). The conjunct may include two or more consonant letters graphically joined in a ligature. Consequently, the particular encoded phonemic character may not have a one-to-one relationship with a particular specified glyph encoding. Thus, an additional encoded phonemic character may be mapped to the specified glyph encoding by the matching module 112. The particular encoded phonemic character may also appear more than once in the specified glyph rendered for display with a user interface from the particular specified glyph encoding. For example, particular encoded phonemic character may have a two-to-one relationship with the particular specified glyph encoding.

For example, in an example embodiment the computer input device 100 may be a QWERTY keyboard. A user may type a particular alphanumeric character of the QWERTY keyboard. The particular alphanumeric character may be associated with a particular character of the simplified Brahmic script. The particular alphanumeric key input data may be represented as an American Standard Code for Information Interchange (ASCII) coding scheme data. In another embodiment an alphanumeric key input data may be represented as an Indian Script Code for Information Interchange (ISCII) is a coding scheme data. In yet other embodiments, the alphanumeric key input data may be represented as Unicode coding scheme data.

The script/speech conversion module 120 may include a set of hardware circuitry and/or software functionality to convert the encoded phonemic character to speech and/or convert speech to the encoded phonemic character. In one particular embodiment, the computer input device 100 may include an automatic speech recognition system that converts a spoken component of a Brahmic language to a machine-readable input. The STT module 124 may convert a speech data to the encoded phonemic character.

In another particular embodiment, the TTS module 122 may render a character set as a speech sound with a text-to-speech system. The text may be in the Brahmic script and/or the simplified phonetic Brahmic script. The computer 104 may include a speech synthesizer.

The graphical user interface 126 may accept input via devices such as a QWERTY computer keyboard and/or mouse and provide articulated graphical output on a computer monitor. The graphical user interface 126 includes Object-oriented user interfaces (OOUIs) and/or application oriented interfaces.

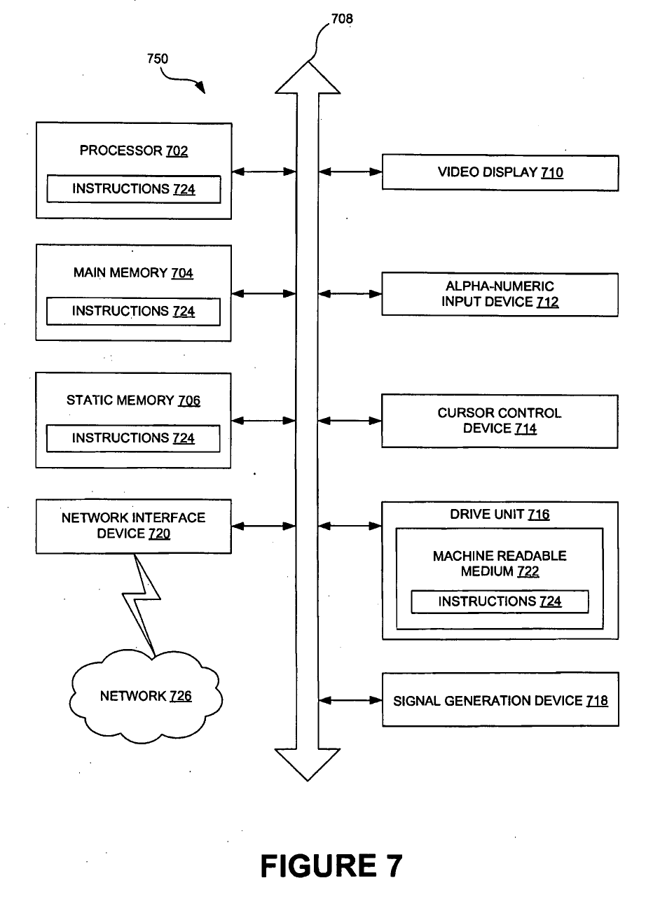

The information processing system may be the computer 104. The computer 104 may be a machine that manipulates data according to a list of instructions. The computer 104 may be the machine as shown in FIG. 7.

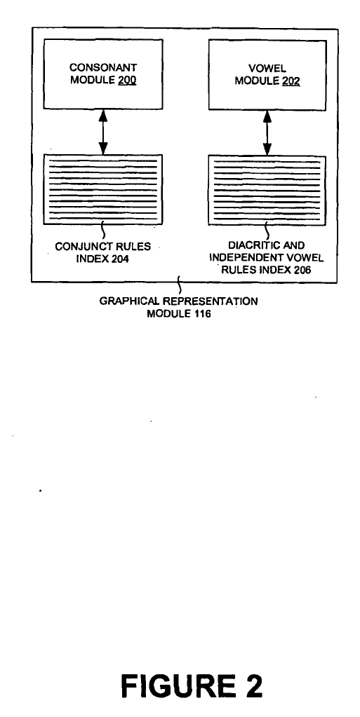

FIG. 2 is an exploded view of graphical representation module illustrated in FIG. 1, according to one embodiment. Particularly FIG. 2 consonant module 200, a vowel module 202, a conjunct rules index 204, and a diacritic and independent vowel rules index 206, according to one embodiment.

In an example embodiment, the graphical representation module 116 may include a consonant module 200, a vowel module 202, a conjunct rules index 204, and a diacritic and independent vowel rules index 206. The consonant module 200 may communicate with the conjunct rules index 204. The vowel module 202 may communicate with the diacritic and independent vowel rules index 206.

The consonant module 200 may include a set of hardware circuitry and/or software functionality to render the specified glyph encoding of the specified Brahmic script into a specified conjunct form according to a list of allowed conjuncts of the specified Brahmic script if the phonemic character comprises a consonant. The consonant module 200 may render the specified glyph encoding for presentation with a user interface according to the set of conjunct rules. The conjunct rules may be included in the conjunct rules index 204. In another example embodiment, the consonant module 200 may use a hash table to associate a particular specified glyph of a consonant encoding with a particular conjunct rule. The conjunct rules may be derived from historical and/or standardized rules of representing a glyph of a specified Brahmic script.

The vowel module 202 may include a set of hardware circuitry and/or software functionality to algorithmically generate the specified glyph encoding of the specified Brahmic script into at least one of an independent form and a diacritic form if the phonemic character comprises a vowel. The diacritic and independent vowel rules may be included in a diacritic and independent vowel rules index 206. The diacritic and independent vowel rules may include a set of rules derived from historical and/or standardized rules of representing a glyph of the specified Brahmic script. In another example embodiment, the vowel module 202 may use a hash table to associate a particular specified glyph encoding a vowel with a particular diacritic rule and/or independent vowel rule. The diacritic rule and/or the consonant rule may be utilized by the graphical representation module 116 to determine a proper form for a consonant with a diacritic symbol.

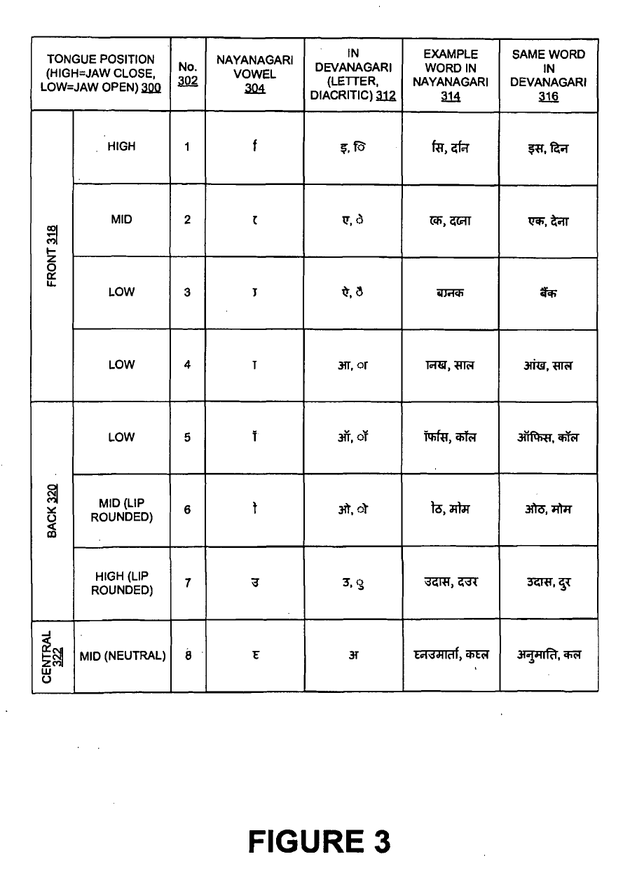

FIG. 3 is a tabular view illustrating categorization of Nayanagari basic vowels according to one embodiment. Nayanagari may be a simplified phonetic script derived from Devanagari. Particularly, FIG. 3 illustrates a column tongue position 300. The tongue position high indicates jaw close and the tongue position low indicates jaw open. FIG. 3 also illustrates a column no. 302, a column Nayanagari vowel 304, a column in Devanagari 312, a column example word in Nayanagari 314, and a column same word in Devanagari 316. The rows of the column tongue position 300 are categorized into three groups. The three groups are front, back, and central. These groups are indicated in three rows of the column tongue position 300 as front 318, back 320, and central 322. The grouping is done on the basis of position of the tongue while pronouncing the vowel.

The Nayanagari vowel characters resemble the corresponding diacritic forms in Devanagari in many respects. The Nayanagari vowel characters are designed to maintain the look and feel of the Nayanagari script as close as possible to that of Devanagari. Other versions of a simplified Brahmic phonetic script may be derived from Devanagari. Nayanagari is one example version. The eight basic vowels of Nayanagari script and characters are: [symbol] [symbol] In another example embodiment using Nobobangla the eight basic vowels are:

[symbol]

[symbol]

The table illustrates eight basic vowels of Nayanagari script in the column Nayanagari vowel 304. The column tongue position indicates the position of the tongue when a vowel is pronounced. The column Nayanagari vowel 304 indicates the written representation of vowel characters. The column name of the vowel 306 is divided into two columns. The column in Devanagari 312 indicates a corresponding diacritic or a letter in Devanagari for any particular vowel. The column, Example Word in Nayanagari 314, indicates an example word in Nayanagari script. The column, Same Word in Devanagari 316 indicates the same word in a standardized form of Devanagari script.

In the simplified Brahmic phonetic script, a vowel may be located in a word in three ways. The simplified Brahmic phonetic script vowel alphabet may be located at the beginning of a word, after one or more consonants, and after or before one or more vowels. When there is more than one consonant before a vowel in a simplified Brahmic phonetic script vowel word, the vowel affects all of those consonants. The simplified Brahmic phonetic script vowels are represented in a form derived from the diacritic-style art. The diacritic-style art may make a word shorter in length and the usage of this style may provide less confusion while reading a word.

FIG. 3 illustrates the generic rules of simplified Brahmic phonetic script vowel according to the particular phonetic Nayanagari script. For example, a Nayanagari character may be located in a word in three ways. The Nayanagari vowel alphabet may be located at the beginning of a word, after one or more consonants, and after or before one or more vowels. When there is more than one consonant before a vowel in a Nayanagari word, the vowel affects all of those consonants. The Nayanagari vowels are represented using the diacritic-style art as represented in the column Nayanagari vowel 304. The diacritic-style art may make a word shorter in length and the usage of this style may provide less confusion while reading a word.

In the simplified Brahmic phonetic script each vowel is represented by a single symbol and is placed in a word as an individual character in a progressive manner. The Nayanagari example illustrates this rule as shown in FIG. 3. Each of the Nayanagari vowels is represented by a single symbol and is placed in a word as an individual character in a progressive manner 314.

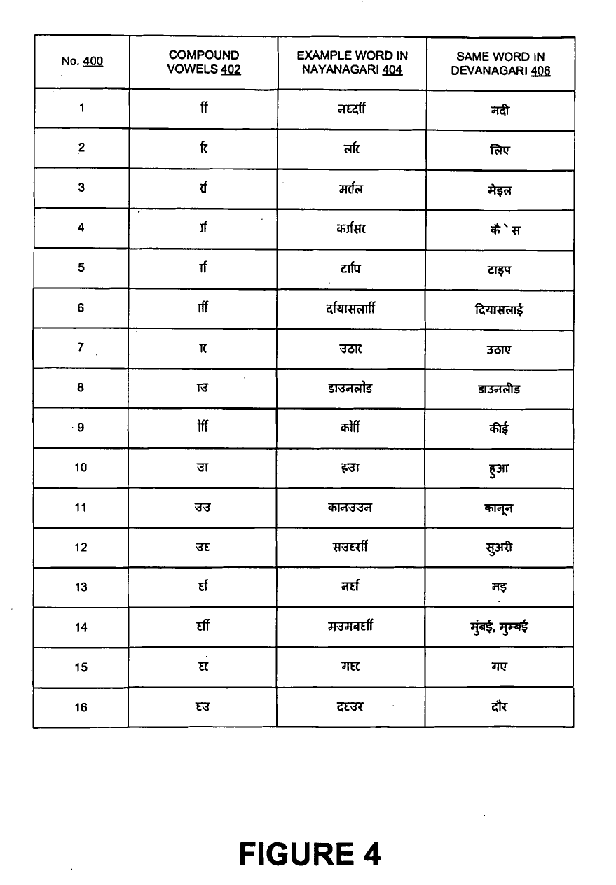

FIG. 4 is a tabular view illustrating the use of compound vowels in Nayanagari, according to one embodiment. Particularly FIG. 4 illustrates a column 400 indicating the number of compound vowels in Nayanagari, a column compound vowels 402, a column an example word in Nayanagari 404, and a column same word in Devanagari 406.

The Compound Vowels column 402 lists the compound vowels in Nayanagari. The compound vowels are formed when two or more Nayanagari vowels are used adjacently in a word. The Example Word in Nayanagari column 404 illustrates the use of compound vowels of the compound vowels column 402 written in Nayanagari script. The Example Word in Devanagari column 406 exemplifies the words illustrated in the column 404 in Devanagari script. The long vowel letters and diacritics of Devanagari are represented by placing the corresponding Nayanagari monopthong vowel twice side by side.

The glyph design of consonants of the simplified Brahmic phonemic script may be derived from and similar to the consonants of the Brahmic script from which the simplified Brahmic phonemic script is derived. For example, a glyph design of the consonant of the Nayanagari script is the same as corresponding a Devanagari consonant in many of the cases.

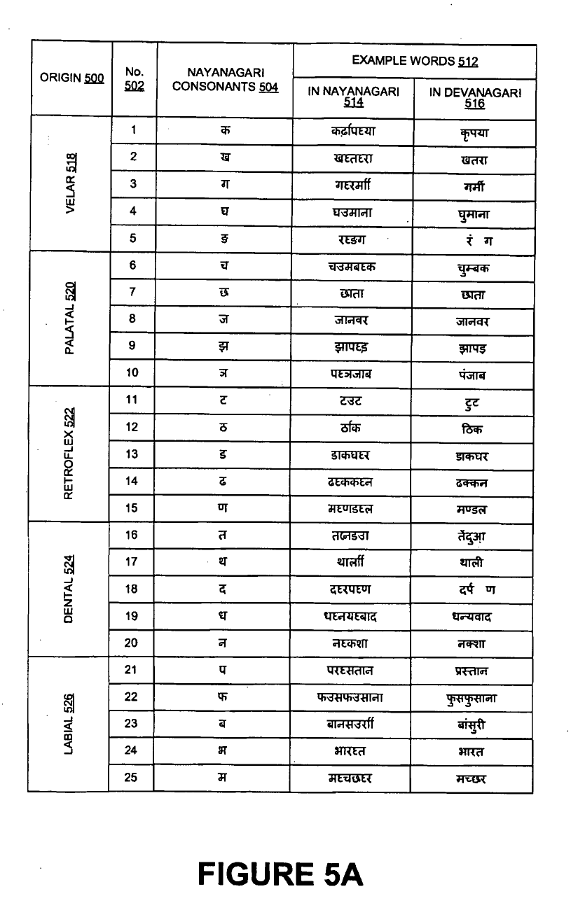

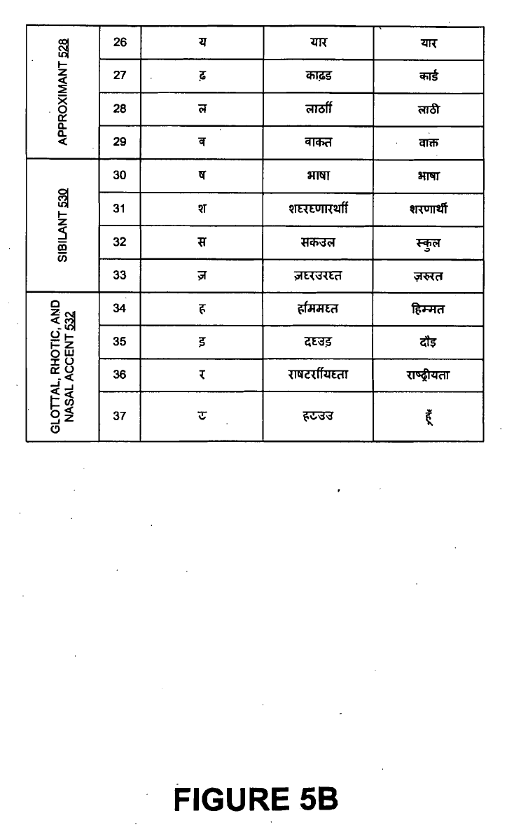

FIG. 5A and 5B are tabular views illustrating consonants of the Nayanagari alphabet and their usage, according to one embodiment. Particularly FIG. 5A and 5B illustrates a column origin 500, a column 502 indicating the number for each consonants, a column Nayanagari consonants 504, a column name of the consonant 506, a column example words 506, a row velar 518, a row palatal 520, a retroflex 522, a dental 524, a labial 526, a row approximant 528, a row sibilant 530, and a row glottal, rhotic, and nasal accent 532, according to one embodiment.

According to one embodiment the column origin 500 is categorized into eight rows to illustrate the eight different groups of the Nayanagari consonants. There are thirty-seven consonants in Nayanagari. The numbers of these consonants are indicated in the column 502. The Nayanagari Consonants column 504 may indicate the consonant alphabet in Nayanagari. The Nayanagari consonants do not include an inherent vowel sound. The Nayanagari consonants represent only the phonemic consonant part of the sound. The Example Words column 512 illustrates the usage of Nayanagari consonants using the example words in Nayanagari 514 and the same words are indicated in Devanagari 516. The consonant types are list in rows as Velar 518, palatal 520 retroflex 522, dental 524, labial 526, approximant 528, sibilant, 530 and glottal, rhotic and nasal accent 532. FIGS. 3 through 5 may be used to generate a set of rules for the indexes of FIG. 2.

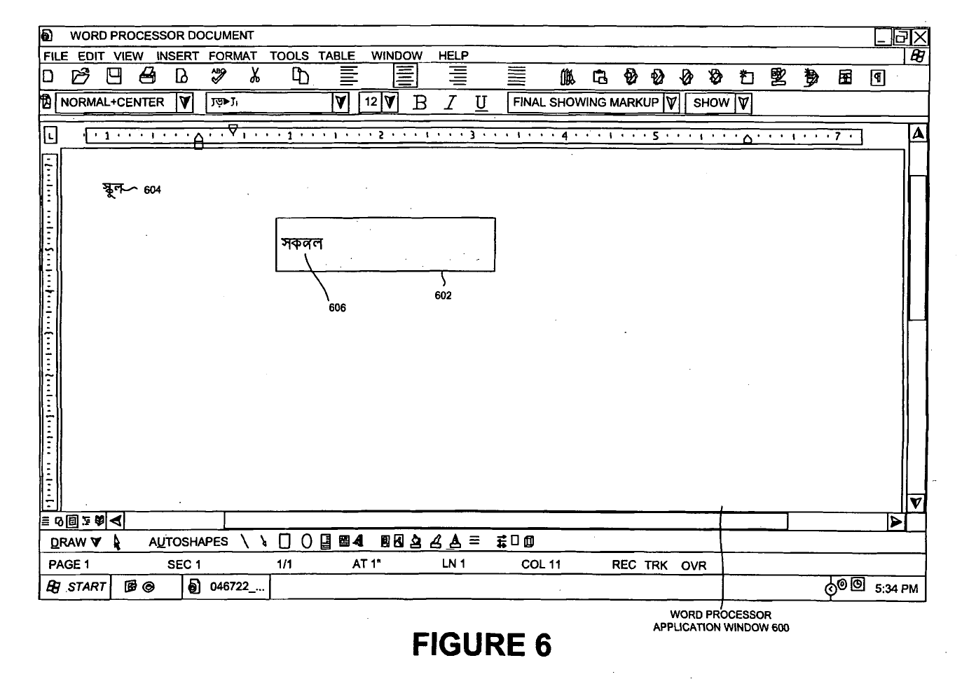

FIG. 6 is a systematic view illustrating a word processor application to convert an input alphanumeric character into a specified encoded Brahmic script, according to one embodiment. Particularly FIG. 6 illustrates a word processor application window 600, a preview window 602, including a word in Nobobangla script [symbol] 606 as typed in, the rendered word in Bangla script [symbol] 604 as processed by algorithms and rules pertaining to Bangla script, according to one embodiment.

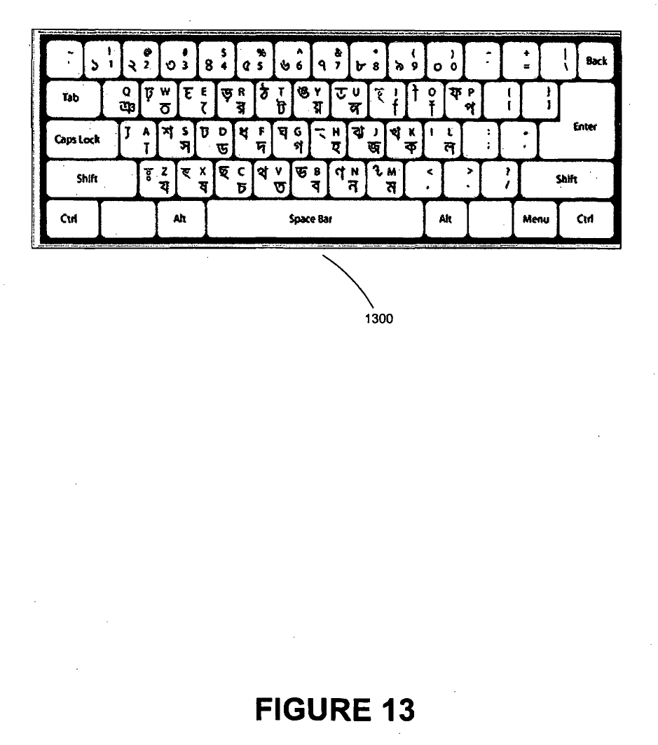

According to one embodiment, the word processor application window 600 may display the input characters in Nobobangla script (a simplified phonetic Brahmic script derived from Bangla) and the same word in Bangla (the specified encoded Brahmic script). The preview window 602 may be a window provided by the conjunct script presenter 118 and the graphical user interface 116 to display the input characters. The Input device may be a QWERTY keyboard. The input alphanumeric character may be associated with a particular character of the simplified Brahmic script with a one to one character mapping as shown in FIG. 13 of Nobobangla Keyboard Map. The word in Nobobangla script [symbol] 606 may be a simplified Brahmic script composed of phonemic characters. The word in Bangla script [symbol] 604 may be a standardized Brahmic abugidic script. The input word may be an ASCII code.

FIG. 7 is a diagrammatic system view of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or the data processing system in which one or more operations disclosed herein are performed. The processor 702 may be a microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically handicapped).

The cursor control device 714 may be a pointing device such as a mouse. The drive unit 716 may be the hard drive, a storage system, and/or other longer term storage subsystem. The signal generation device 718 may be a bios and/or a functional operating system of the data processing system. The network interface device 720 may be a device that performs interface functions such as code conversion, protocol conversion and/or buffering required for communication to and from the network 726. The machine readable medium 722 may provide instructions on which any of the methods disclosed herein may be performed. The instructions 724 may provide source code and/or data code to the processor 702 to enable any one or more operations disclosed herein.

FIG. 8 is a flow chart illustrating conversion of ASCII phonemic simple Brahmic word to Unicode Brahmic, according to one embodiment. In operation 800, a QWERTY ASCII of a word is captured as a simple and linear Brahmic script. For example the Brahmic script may be Nobobangla (a simplified Brahmic script derived from the Bangla script), Nayanagari etc. In operation 802, one or more consecutive vowels are looked up as they are typed in and converted to appropriate Unicode encodings (as diacritic or one or more independent vowels) using hash tables and algorithms. For example, a vowel module may algorithmically generate the specified glyph encoding of the specified Brahmic script into an independent form and a diacritic form. The Unicode encoding is rendered as one or more appropriate glyphs at the selected window. In operation 804, one or more consecutive consonants are looked up as they are typed in and converted to appropriate Unicode encodings (as a conjunct or one or more independent consonants) using hash tables and algorithms. For example, a conjunct module may render the specified glyph encoding of the specified Brahmic script into a specified conjunct form if the phonemic character includes a consonant. The Unicode is rendered as one or more appropriate glyphs at the selected window.

In operation 806, the other characters are converted to appropriate Unicode and are displayed. For example the encoder module 114 of the computer 104 may convert the encoded phonemic character to the specified glyph encoding. In operation 808, it is checked whether the characters have reached the end of a word. If the characters have reached the end of a word then operation 810 is performed; otherwise the functions of operation 800-808 are performed. In operation 810, the end of word character is converted to Unicode and the converted Unicode is rendered appropriately. For example the abugidic script presenter 118 may render the converted Unicode on the selected window. In operation 812, it is checked for the end of typing. If the typing is not finished the steps from operation 800-812 are repeated; otherwise the conversion is stopped.

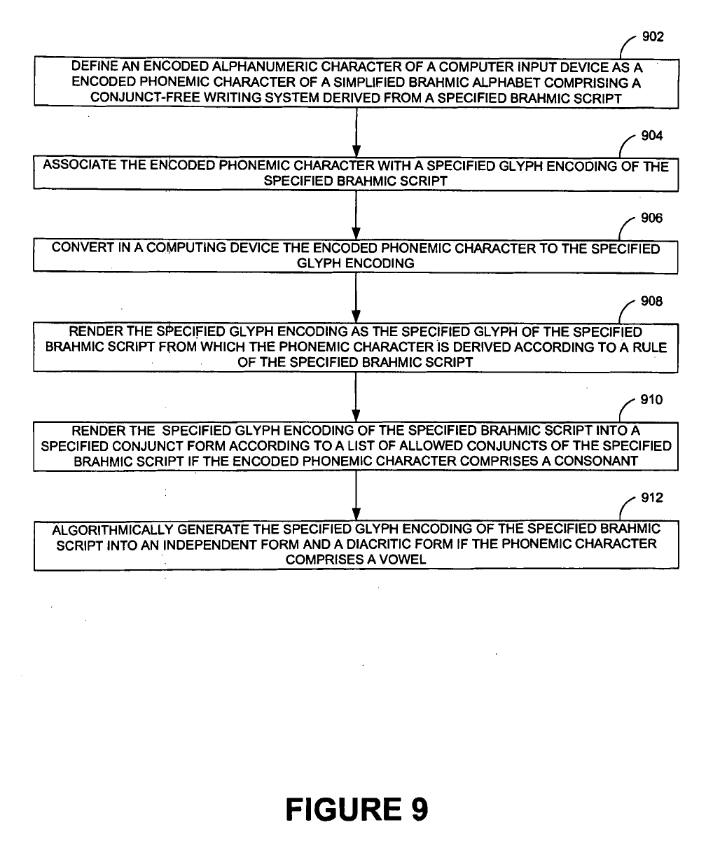

FIG. 9 is a process flow illustrating encoding alphanumeric character to a specified Brahmic script, according to one embodiment. In operation 902, an encoded alphanumeric character of a computer input device may be defined as an encoded phonemic character of a simplified Brahmic alphabet including a conjunct-free writing system derived from a specified Brahmic script. For example, the encoded alphanumeric character of a computer input device 100 may be defined using the mapping module 110 of a computer 104. The encoded alphanumeric character and the encoded phonemic character may have a one-to-one relationship. In operation 904, the encoded phonemic character may be associated with a specified glyph encoding of the specified Brahmic script.

In operation 906, the encoded phonemic character may be converted to the specified glyph encoding in a computing device. For example, the phonemic character may be converted to the glyph encoding using the encoder module 114. In operation 908, the specified glyph encoding may be rendered as the specified glyph of the specified Brahmic script from which the phonemic character may be derived according to a rule of the specified Brahmic script. In operation 910, the specified glyph encoding of the specified Brahmic script may be rendered into a specified conjunct form according to a list of allowed conjuncts of the specified Brahmic script if the encoded phonemic character includes a consonant. For example, the consonant module 200 may render the specified glyph encoding of the specified Brahmic script.

In operation 912, the specified glyph encoding of the specified Brahmic script may be algorithmically generated into an independent form and a diacritic form if the phonemic character includes a vowel. For example, the diacritic and independent vowel rules index 206 may render the specified glyph encoding of the specified Brahmic script to be generated in the independent form and diacritic form.

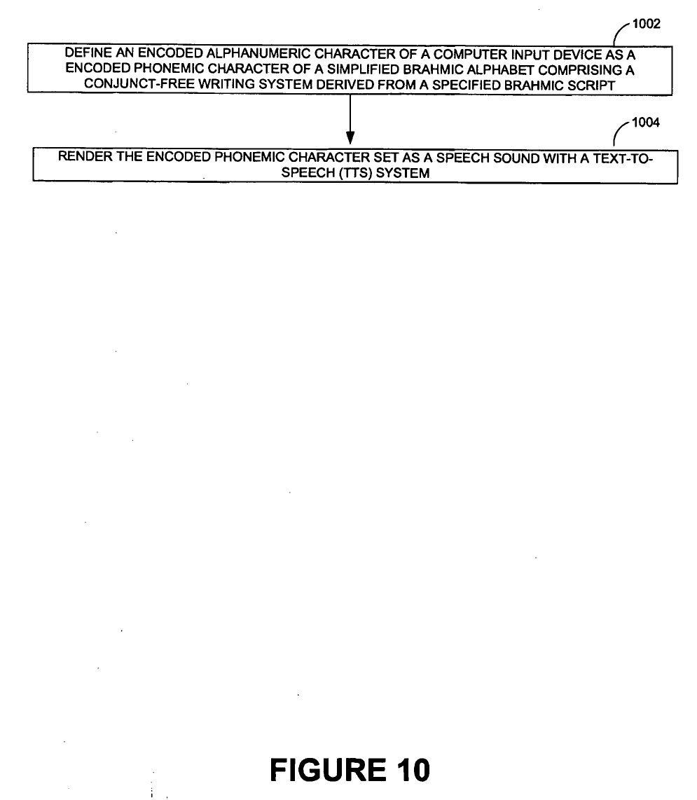

FIG. 10 is a process flow illustrating conversion of a spoken component of the Brahmic language to the encoded phonemic character, according to another embodiment. In operation 1002, an encoded alphanumeric character of a computer input device may be defined as an encoded phonemic character of a simplified Brahmic alphabet including a conjunct-free writing system derived from a specified Brahmic script. For example, the encoded alphanumeric character of a computer input device 100 may be defined using the mapping module 110 of a computer 104. The encoded alphanumeric character and the encoded phonemic character may have a one-to-one relationship. In operation 1004, the encoded phonemic character set may be rendered as a speech sound with a text-to-speech (TTS) system. For example, the TTS module 122 may render the encoded phonemic character set as a speech sound.

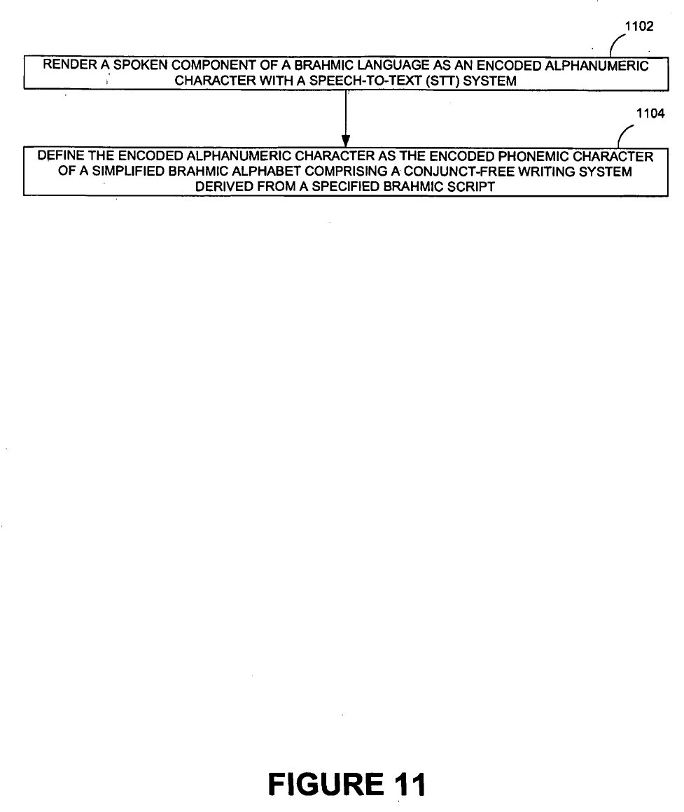

FIG. 11 is a process flow illustrating the mapping of a phonemic character with a data associated with a computer input device, according to one embodiment. In operation 1102, a spoken component of a Brahmic language may be rendered as an encoded alphanumeric character with speech-to-text (STT) system. In operation 1104, the encoded alphanumeric character may be defined as an encoded phonemic character of a simplified Brahmic alphabet including a conjunct-free writing system derived from the spoken Brahmic language. In an example embodiment, the system of FIG. 1 and FIG. 2 may be utilized to perform the process flow of FIG. 11. Furthermore, the process flow illustrated by FIG. 9 may utilized to further process the result of operation 1104.

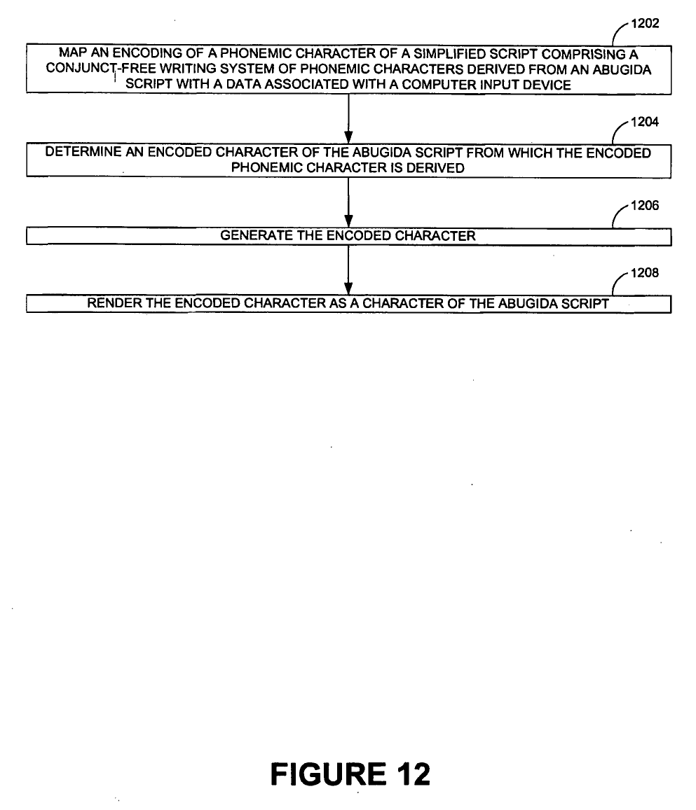

FIG. 12 is a process flow illustrating mapping a phonemic character with a data associated with a computer input device, according to one embodiment. In operation 1202, an encoding of a phonemic character of a simplified script including a conjunct-free writing system of phonemic characters derived from an abugida script may be mapped with a data associated with a computer input device. For example, the encoding of phonemic character including conjunct-free writing system may be mapped with data associated with computer input device 100 using the mapping module 110. In operation 1204, an encoded character of the abugida script from which the encoded phonemic character is derived may be determined. In operation 1106, the encoded character may be generated. In operation 1208, the encoded character may be rendered as a character of the abugida script. In another example embodiment, the system of FIG. 1 and FIG. 2 may be utilized to perform the process flow of FIG. 12.

FIG. 13 illustrates a QWERTY keyboard with a Nobobangla Keyboard Map 1300. In a particular embodiment, the input alphanumeric character keys may be associated with a particular character of a Nobobangla script with a one to one character mapping.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry, firmware, software or any combination of hardware, firmware, or software embodied in a machine readable medium. For example, the various electrical structures and methods may be embodied using transistors, logic gates, application specific integrated (ASIC) circuitry or Digital Signal Processor (DSP) circuitry.

Particularly, the mapping module 110, the matching module 112, the encoder module 114, the abugidic graphical representation module 116, the script/speech conversion module 120, the TTS module 122, and the STT module 124 of FIG. 1, and the other modules may be enabled using software and/or using transistors, logic gates, and electrical circuits (e.g., application specific integrated ASIC circuitry) such a simplified script input circuit, a mapping circuit, a matching circuit, an encoder circuit, an abugidic graphical representation circuit, a script/speech conversion circuit, a TTS circuit, a SST circuit, a conjunct script output circuit and other circuit.

In addition, it will be appreciated that the various operations, processes, and methods disclosed herein may be embodied in a machine-readable medium or a machine accessible medium compatible with a data processing system, and may be performed in any order. Accordingly, the Specification and Drawings are to be regarded in an illustrative rather than a restrictive sense.

What is claimed is:

1. A computer-implemented method comprising:
defining an encoded alphanumeric character of a computer input device as an encoded phonemic character of a simplified Brahmic alphabet comprising a conjunct-free writing system derived from a specified Brahmic script, and wherein the encoded alphanumeric character and the encoded phonemic character have a one-to-one relationship; and
associating the encoded phonemic character with a specified glyph encoding of the specified Brahmic script.

2. The method of claim 1 further comprising:
converting in a computing device the encoded phonemic character to the specified glyph encoding; and
rendering the specified glyph encoding as the specified glyph of the specified Brahmic script from which the encoded phonemic character is derived according to a rule of the specified Brahmic script.

3. The method of claim 2 further comprising:
rendering the specified glyph encoding of the specified Brahmic script into a specified conjunct form according to a list of allowed conjuncts of the specified Brahmic script if the encoded phonemic character comprises a consonant.

4. The method of claim 3 further comprising:
algorithmically generating the specified glyph encoding of the specified Brahmic script into at least one of an independent form and a diacritic form if the phonemic character comprises a vowel.

5. The method of claim 4 further comprising:
defining a diphthong of the specified Brahmic script as a specified combination of phonemic vowel encodings, and
defining a long vowel of the specified Brahmic script as an other specified combination of phonemic vowel encodings.

6. The method of claim 5 further comprising:
rendering the encoded phonemic character as a phonemic character; and
determining a shape of the phonemic character to substantially comprise an other shape of the specified glyph.

7. The method of claim 6,
wherein the computer input device comprises at least one of a QWERTY keyboard, a touch screen device, and an optical character recognition device,
wherein the encoded phonemic character comprises at least one of a Unicode code and an American Standard Code for Information Interchange (ASCII) code; and
wherein the specified glyph encoding comprises at least one of a Unicode code and an ASCII code.

8. The method of claim 7 further comprising:
rendering the specified glyph encoding as the specified glyph according to a specified aesthetic design parameter historically associated with the specified Brahmic script; and
wherein the phonemic character represented by the encoded phonemic character is free of an inherent vowel of the specified glyph of the specified Brahmic script from which the phonemic character is derived if the phonemic character is a consonant.

9. The method of claim 8,
associating a particular encoded phonemic character with a majuscule encoded alphanumeric character; and
associating an other encoded phonemic character with a minuscule encoded alphanumeric character.

10. The method of claim 1 further comprising:
rendering the encoded phonemic character set as a speech sound with a text-to-speech (TTS) system.

11. The method of claim 1 further comprising:
converting a spoken component of a Brahmic language to the encoded phonemic character, and
wherein the computer input device is an automatic speech recognition system that converts the spoken component of the Brahmic language to the encoded phonemic character.

12. The method of claim 1, wherein a machine is caused to perform the method of claim 1 when a set of instructions in a form of a machine-readable medium is executed by the machine.

13. A system comprising:
a computer input device;
a mapping module of a computer to define an encoded alphanumeric character of the computer input device as a encoded phonemic character of a simplified Brahmic alphabet comprising a conjunct-free writing system derived from a specified Brahmic script, and wherein the encoded alphanumeric character and the encoded phonemic character have a one-to-one relationship; and
a matching module of the computer to associate the encoded phonemic character with a specified glyph encoding of the specified Brahmic script.

14. The system of claim 13 further comprising:
a graphical representation module to render the specified glyph encoding as a specified glyph of the specified Brahmic script from which the phonemic character is derived according to a rule of the specified Brahmic script; and
an encoder module of the computer to convert the encoded phonemic character to the specified glyph encoding.

15. The system of claim 14 further comprising:
a consonant module to render the specified glyph encoding of the specified Brahmic script into a specified conjunct form according to a list of allowed conjuncts of the specified Brahmic script if the phonemic character comprises a consonant;
a vowel module to algorithmically generate the specified glyph encoding of the specified Brahmic script into at least one of an independent form and a diacritic form if the phonemic character comprises a vowel.

16. The system of claim 15, wherein the graphical representation module renders the encoded phonemic character as a phonemic character.

17. The system of claim 16 further comprising:
a TTS module to render the specified glyph of the specified Brahmic script as a speech sound with a text-to-speech system and to render the encoded phonemic character as an other speech sound;
a STT module to convert a speech data to the encoded phonemic character,
wherein the computer input device is an automatic speech recognition system that converts a spoken component of a Brahmic language to a machine-readable input; and
wherein the graphical representation module determines a shape of the encoded phonemic character to substantially comprise an other shape of the specified glyph of the specified Brahmic script such that the phonemic character retains an appearance similar to the specified glyph.

18. The system of claim 13,
wherein the encoder module converts the specified glyph encoding to the encoded phonemic character.

19. A computer-implemented method comprising:
mapping an encoding of a phonemic character of a simplified script comprising a conjunct-free writing system of phonemic characters derived from an abugida script with a data associated with a computer input device,
determining an encoded character of the abugida script from which the encoded phonemic character is derived; and
generating the encoded character.

20. The method of claim 19 further comprising:
rendering the encoded character as a character of the abugida script.
